(19) United States
(12) Patent Application Publication
(10) Pub. No.: US 2011/0246694 A1
(43) Pub. Date: Oct. 6, 2011

(54) MULTI-PROCESSOR SYSTEM AND LOCK ARBITRATION METHOD THEREOF

(75) Inventor: Naoya Ichinose, Osaka (JP)

(73) Assignee: PANASONIC CORPORATION, Osaka (JP)

(21) Appl. No.: 13/157,958

(22) Filed: Jun. 10, 2011

Related U.S. Application Data
(63) Continuation of application No. PCT/JP2009/005101, filed on Oct. 2, 2009.

(30) Foreign Application Priority Data
Dec. 12, 2008 (JP) 2008-316460

(51) Int. Cl. G06F 13/00

(52) U.S. Cl. 710/200

(57) ABSTRACT

A multi-processor system of the present invention comprises a plurality of processors each configured to lock a shared resource and process a task; each of the processors including a lock wait information storage unit for storing lock wait information indicating whether or not the processor is waiting for acquirement of a lock of the shared resource; and a lock acquirement priority information storage unit for storing lock acquirement priority information indicating a priority according to which the shared resource is acquired; and each of the processors being configured to acquire the lock of the shared resource based on the lock wait information and the lock acquirement priority information.

This is a continuation application under 35 U.S.C. 111(a) of pending prior International application No. PCT/JP2009/005101, filed on Oct. 2, 2009. The disclosure of Japanese Patent Application No. 2008-316460 filed on Dec. 12, 2008 including specification, drawings and claims is incorporated here in by reference in its entirety.

### BACKGROUND OF THE INVENTION

1. Field of the Invention

The present invention relates to a multi-processor system. Particularly, the present invention relates to a system in which a plurality of processors require a lock of a resource, and a lock arbitration method thereof

2. Description of the Related Art

In a lock arbitration method of a conventional multi-processor system, a resource flag indicating whether or not a lock is being executed is used. The resource flag is ON (‘1’) when there exists a processor which is executing a lock in the system and is OFF (‘0’) when there does not. Each processor checks the resource flag without fail before executing the lock, and the system permits the processor to execute the lock only when there does not exist another processor executing the lock, i.e., the corresponding resource flag is OFF. On the other hand, if there exists another processor executing the lock, i.e., the corresponding resource flag is ON, the processor is not permitted to execute the lock at that point of time and is placed in a wait state until another processor finishes the lock and the resource flag changes to OFF. In this manner, in the conventional multi-processor system, the lock to be executed by the processors constituting the system is arbitrated.

However, in the above conventional multi-processor system, the lock to be executed by the plural processors is arbitrated based on only information indicating whether or not the lock is being executed, i.e., the resource flag, and any consideration is not given to a processor waiting for the permission (grant) of the lock. For this reason, the processor permitted to execute the lock is determined simply according to, for example, the order in which a lock request is received, which brings about a situation where the processors to which permission of the lock is given become unequal. Further, every time a particular processor which attempts to execute the lock, checks the resource flag, another processor is executing the lock, which leads to a situation where the particular processor will be placed in a wait state without permission to the lock, and processor time out occurs.

As a Prior Art Example for preventing the above mentioned processor time out, for example, a technique disclosed in Japanese Laid-Open Patent Application Publication No. Hei. 2001-344195 is known. This Prior Art Example includes a lock flag indicating there exists a processor executing a lock, a failure flag indicating that a lock request issued by each processor has failed, and a success flag indicating that a lock request reissued by each processor has been successful, and the lock is arbitrated by a distributed (decentralized) arbitration scheme in which individual processors determine the order of the same request processing, and execute the processing. This allows all of the processors to have their resource lock requests met without fail without depending on the order in which a resource lock arbiter accepts the requests, and makes it possible to prevent occurrence of the processor time out.

### SUMMARY OF THE INVENTION

In recent years, with improvement of performance of electronic devices, emphasis has been put on the fact that specified functions are implemented in real time. For example, the auto-focusing functions of digital cameras are required to achieve high-speed responsiveness when taking pictures serially. Also, the functions of cellular phones preferably have high-speed responsiveness to the operation of operation buttons during use, in order to enhance their commercial values.

Regarding achievement of the above real-time functions, the Prior Art Example disclosed in Japanese Laid-Open Patent Application Publication No. Hei. 2001-344195 has the following problems. In a case where a particular processor issues a request for locking a resource, if there exists another processor in a lock acquirement wait state at that point of time, it succeeds in the lock, and the particular processor is placed in a lock acquirement wait state until another processor releases (frees) the lock. This procedure is repeated to correspond to another processors in a lock acquirement wait state, which could result in a situation where the particular processor continues to be placed in a lock acquirement wait state for a period of time during which the procedure is repeated. Especially, in real time OS in a built-in system, the order in which processing is executed is determined according to the priority assigned to the processing. However, the order in which a lock is acquired is determined by instantaneous FIFO (First in First out) in lock request processing irrespective of the priority assigned to the processing. Because of this, there may be a chance that processing assigned with a higher priority continues to be placed in a lock acquirement wait state and it is difficult to ensure that rear-time processing is performed.

The present invention is directed to solving the above mentioned problem, and an object of the present invention is to provide a multi-processor system capable of ensuring real-time processing and a lock arbitration method thereof

To solve the above described problem, a multi-processor system of the present invention, comprises a plurality of processors each configured to lock a shared resource and process a task; each of the processors including a lock wait information storage unit for storing lock wait information indicating whether or not the processor is waiting for acquirement of a lock of the shared resource; and a lock acquirement priority information storage unit for storing lock acquirement priority information indicating a priority according to which the shared resource is acquired; and each of the processors being configured to acquire the lock of the shared resource based on the lock wait information and the lock acquirement priority information.

In accordance with this configuration, if there exists another processor in a lock wait state at a time point when it becomes necessary for a particular processor to lock the shared resource, the processor with a higher priority, among these processors, acquires the lock of the shared resource. As a result, real-time processing can be ensured.

The lock acquirement priority information storage unit may be constituted by a register for storing the lock acquirement priority information.

The multi-processor system may be configured not to change the lock acquirement priority information.

The multi-processor system may be configured to change the lock acquirement priority information.

The multi-processor system may be configured to change the lock acquirement priority information in a specific cycle.

Each of the processors may be configured to change the lock acquirement priority information, according to a priority of a task being executed or interrupt processing.

Each of the processors may be configured to change the lock acquirement priority information, according to the number of times trial is made to acquire the lock.

The lock wait information storage unit may comprise a register for storing the lock wait information.

A method of arbitrating a lock in a multi-processor system of the present invention, including a plurality of processors each configured to lock a shared resource and process a task; comprising: storing lock wait information indicating whether or not each of the processors is waiting for acquirement of a lock of the shared resource, in each of the processors; storing lock acquirement priority information indicating a priority according to which each of the processors acquires a lock of the shared resource, in each of the processors; and acquiring the lock of the shared resource based on the lock wait information and the lock acquirement priority information, in each of the processors.

In accordance with this configuration, if there exists another processor in a lock wait state at a time point when it becomes necessary for a particular processor to lock the shared resource, the processor with a higher priority, among these processors, acquires the lock of the shared resource. As a result, real-time processing can be ensured.

Each of the processors may store the lock acquirement priority information in a register.

Each of the processors may not change the lock acquirement priority information.

Each of the processors may change the lock acquirement priority information.

Each of the processors may change the lock acquirement priority information in a specific cycle.

Each of the processors may change the lock acquirement priority information, according to a priority of a task being executed or interrupt processing.

Each of the processors may change the lock acquirement priority information, according to the number of times trial is made to acquire the lock.

Each of the processors may store the lock wait information in a register.

A camera of the present invention comprises a controller unit including the above stated multi-processor system and the shared resource locked by each of the processors constituting the multi-processor system; the controller unit being configured to control an operation of the camera.

The present invention is configured as described above, and achieves an advantage that a multi-processor system capable of ensuring real-time processing and a lock arbitration method thereof can be provided.

The above and further objects, features and advantages of the present invention will more fully be apparent from the following detailed description of preferred embodiments with accompanying drawings.

### BRIEF DESCRIPTION OF THE DRAWINGS

FIG. 1 is a circuit diagram showing a configuration of a multi-processor system according to Embodiment 1 of the present invention.

FIG. 2 is a flowchart showing a lock acquirement operation of one processor in the multi-processor system of FIG. 1.

FIGS. 3(a) and 3(b) are schematic views showing a lock acquirement operation of the multi-processor system of FIG. 1, in comparison with a lock acquirement operation of Comparative Example, wherein FIG. 3(a) is a view showing the lock acquirement operation of the multi-processor system of FIG. 1, and FIG. 3(b) is a view showing the lock acquirement operation of Comparative Example.

FIG. 4 is a circuit diagram showing a configuration of a multi-processor system according to Embodiment 2 of the present invention.

FIG. 5 is a flowchart showing a lock acquirement operation of one processor in the multi-processor system of FIG. 4.

FIG. 6 is a block diagram showing a functional configuration of a digital still camera according to Embodiment 3 of the present invention.

### DETAILED DESCRIPTION OF THE PREFERRED EMBODIMENTS

Hereinafter, embodiments of the present invention will be described in detail with reference to the drawings. Throughout the drawings, the same or corresponding constituents are designated by the same reference symbols and will not be described repetitively.

### Embodiment 1

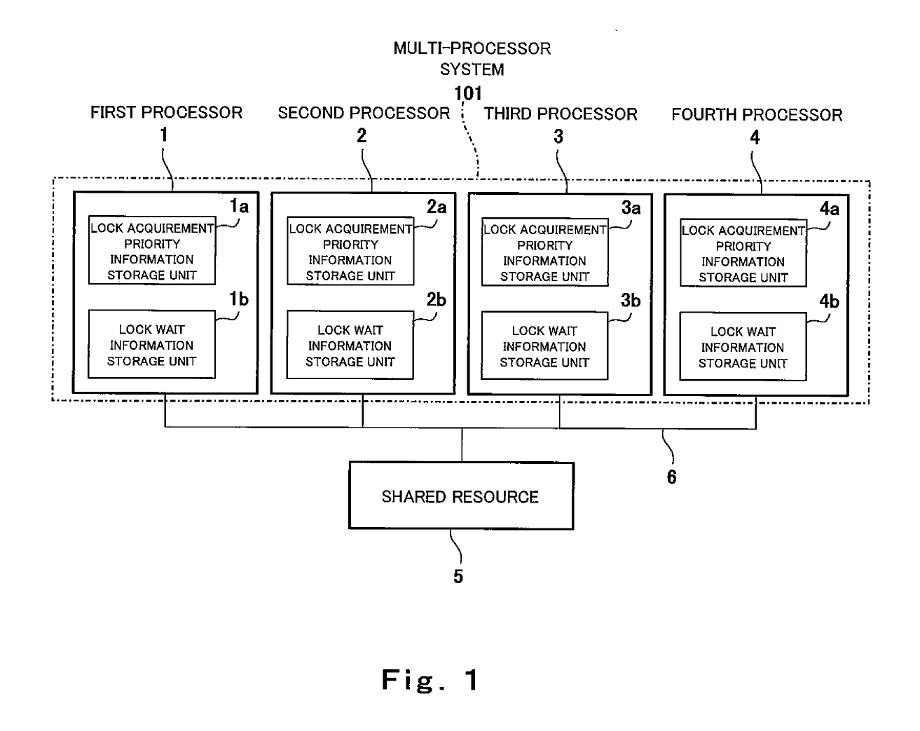

FIG. 1 is a circuit diagram showing a configuration of a multi-processor system according to Embodiment 1 of the present invention.

As shown FIG. 1, a multi-processor system 101 of Embodiment 1 includes first to fourth processors 1˜4. The first to fourth processors 1˜4 are connected to a shared (common) resource 5 through a bus 6. The first processor 1 includes a lock acquirement priority information storage unit la and a lock wait information storage unit 1b. The second processor 2 includes a lock acquirement priority information storage unit 2a and a lock wait information storage unit 2b. The third processor 3 includes a lock acquirement priority information storage unit 3a and a lock wait information storage unit 3b. The fourth processor 4 includes a lock acquirement priority information storage unit 4a and a lock wait information storage unit 4b.

The lock acquirement priority information storage units 1a, 2a, 3a, and 4a serve to store lock acquirement priority information and are constituted by circuit elements capable of storing data. In present embodiment, the lock acquirement priority information storage units 1a, 2a, 3a, and 4a are constituted by, for example, registers, respectively. The lock acquirement information indicates a priority according to which the lock of the shared resource 5 is acquired. The lock acquirement information indicates a priority according to which the processor including the lock acquirement information storage unit for storing this lock acquirement information acquires the lock of the shared resource 5. In present embodiment, the priority is assigned to each of the processors 1˜4. The priority may be, for example, order of priority, rank, point number, etc., so long as it is information indicating the degree of priority. In present embodiment, for example, the order of priority “4”, “3”, “2”, and “1” (priority is higher as the corresponding number is smaller) are assigned preliminarily to the first to fourth processors 1˜4, respectively. This priority is not changed.

The lock wait information storage units 1b, 2b, 3b, and 4b serve to store lock wait information and are constituted by circuit elements capable of storing data. In present embodiment, the lock wait information storage units 1b, 2b, 3b, and 4b are constituted by, for example, registers, respectively. The lock wait information indicates whether or not the processor is waiting for acquirement the lock of the shared resource 5. In present embodiment, the lock wait information indicates whether or not the processor including the lock wait information storage unit storing this lock wait information is waiting for acquirement the lock of the shared resource 5. Each processor renders the lock wait information stored in the corresponding lock wait information storage unit “the processor is in a lock wait state” when it has failed to acquire the lock of the shared resource 5, and renders the lock wait information “the processor is not in a lock wait state” when it has succeeded in acquirement of the lock of the shared resource 5.

As described later, each of the processors 1˜4 accesses the lock wait information storage units in another ones of the processors 1˜4 and refers to the lock wait information stored in the lock wait information storage units to determine whether or not another ones of the processors 1˜4 are waiting for acquirement of the lock of the shared resource 5. Alternatively, each of the lock wait information storage units 1b, 2b, 3b, and 4b of the processors 1˜4 may be configured to store the lock wait information relating to all of the processors 1˜4. In such a configuration, each of the processors 1 4 has only to refer to the information stored in respective lock wait information storage units. In further alternative, a single lock wait information storage unit common to all of the processors 1˜4 may be provided to store the lock wait information relating to all of the processors 1˜4. In this case, each of the processors 1˜4 accesses the common lock wait information storage unit and refers to the lock wait information relating to all of the processors 1˜4.

The shared resource 5 has a resource required to be locked by a plurality of processors, and provides the resource to any one of the first processor 1, the second processor 2, the third processor 3, and the fourth processor 4. The shared resource 5 can provide the resource to only one of the first processor 1, the second processor 2, the third processor 3, and the fourth processor 4. For example, when the first processor 1 acquires the resource from the shared resource 5, resource lock must be executed to inhibit the resource from being provided to the second processor 2, the third processor 3, and the fourth processor 4, which are likely to acquire the resource from the shared resource 5. As the shared resource, for example, there are a memory (RAM, ROM, etc.), I/O (register, etc.).

Next, the operation (lock arbitration method of the multi-processor system of the present embodiment) of the multi-processor system configured as described above will be described.

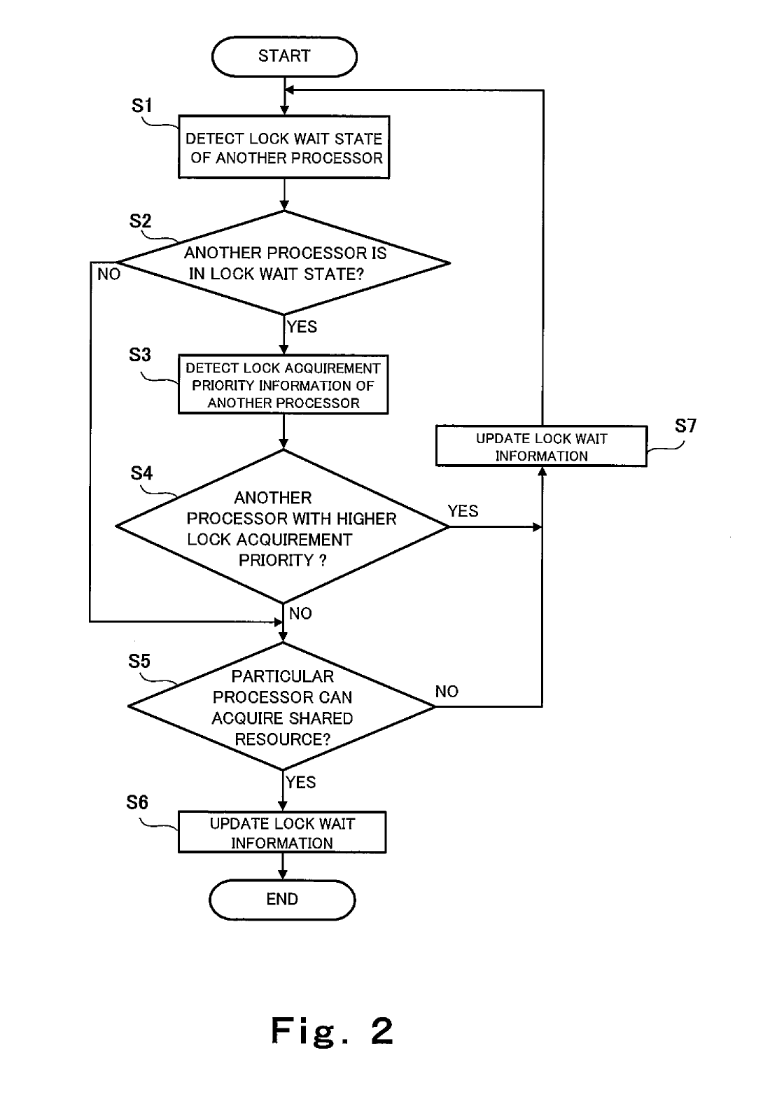

FIG. 2 is a flowchart showing a lock acquirement operation of one processor in the multi-processor system of FIG. 1.

Hereinafter, for example, a case where one processor is the first processor 1 will be described. The same operation occurs in cases where one processor is any one of the second to fourth processors 2 to 4 and will not be described repetitively.

Firstly, it is assumed that the first processor 1 is currently not executing the lock of the shared resource 5. In this state, the lock wait information in the lock wait information storage unit 1b of the first processor 1 is “the processor 1 is not in a lock wait state”.

In this state, upon a need for the first processor 1 to lock the shared resource arising, the first processor 1 tries to acquire a lock, and firstly detects the lock wait states of the processors 2˜4 (step S1). To be specific, the first processor 1 accesses the lock wait information storage units 2b˜4b of the processors 2˜4 and refers to their lock wait information.

Then, the first processor 1 determines whether or not there exists another processor in a lock wait state, among the processors 2˜4 (step S2). If it is determined that there does not exist another processor in a lock wait state, among the processors 2˜4 (NO in step S2), the process moves to step S5 which will be described later.

On the other hand, if it is determined that there exists another processor in a lock wait state, among the processors 2˜4 (YES in step S2), the first processor 1 detects the lock acquirement priority information of the corresponding processor of the processors 2˜4 (step S3). To be specific, the first processor 1 accesses the corresponding lock acquirement priority information storage unit among the lock acquirement priority information storage units 2a˜4a of the processors 2˜4 and refers to their lock acquirement priority information.

Then, the first processor 1 executes step S4. In step S4, the first processor 1 obtains the lock acquirement priority information from the lock acquirement priority information storage unit la of itself and compares this information to the lock acquirement priority information of the corresponding one of the processors 2˜4 to determine whether or not there exists another processor assigned with a higher lock acquirement priority than that of the first processor 1, among the processors 2˜4.

If it is determined that there exists another processor assigned with a higher lock acquirement priority than that of the first processor 1, among the processors 2˜4 (YES in step S4), the first processor 1 updates the lock wait information in the lock wait information storage unit 1b to “the processor 1 is in a lock wait state” (step S7). Thereafter, the process returns to step S1, and the first processor 1 makes a next trial to acquire the lock. In other words, the multi-processor system 101 inhibits the first processor 1 from accessing the shared resource 5.

On the other hand, if it is determined that there does not exist another processor assigned with a higher lock acquirement priority than that of the first processor 1 (NO in step S4), the first processor 1 executes step S5. In step S5, the first processor 1 determines whether or not the first processor 1 can acquire the shared resource 5. To be specific, if another processor, i.e., the second processor 2, the third processor 3, or the fourth processor 4 is holding the shared resource 5, then the first processor 1 determines that it cannot acquire the shared resource 5, whereas if the second processor 2, the third processor 3, and the fourth processor 4 are not holding the shared resource 5, the first processor 1 determines that it can acquire the shared resource 5. In the present embodiment, for example, when each of the processors 1˜4 has acquired and is holding the shared resource 5, a flag indicating “resource has been acquired” is ON (this flag is stored in a predetermined flag storage unit), whereas when each of the processors 1˜4 has not acquired and is not holding the shared resource 5, a flag indicating “resource has been acquired” is not ON. In present embodiment, the first processor 1 determines whether or not the first processor 1 can acquire the shared resource 5 with reference to the above flag of each processor. If the flag indicating “resource has been acquired” is turned ON by the second processor 2, the third processor 3, or the fourth processor 4, the first processor 1 determines that the first processor 1 cannot acquire the shared resource 5, whereas if the flag indicating “resource has been acquired” is not turned ON by the second processor 2, the third processor 3, and the fourth processor 4, the first processor 1 determines that the first processor 1 can acquire the shared resource 5. Alternatively, apart from the flag indicating “resource has been acquired,” a flag indicating “resource has not been acquired” may be prepared and when each of the processors 1˜4 has not acquired the shared resource 5, the flag indicating “resource has not been acquired” may be ON (this flag is stored in a predetermined flag storage unit). In this case, the first processor 1 determines whether or not the first processor 1 can acquire the shared resource 5 with reference to the above flag of each processor. To be specific, if the flag indicating “resource has been acquired” is turned ON by the second processor 2, the third processor 3, or the fourth processor 4, the first processor 1 determines that it cannot acquire the shared resource 5, whereas if the flag indicating “resource has not been acquired” is turned ON by the second processor 2, the third processor 3, and the fourth processor 4, the first processor 1 determines that it can acquire the shared resource 5.

If it is determined that that the first processor 1 cannot acquire the shared resource 5 (NO in step S5), the first processor 1 executes step S7. Then, the process returns to step S1 and the first processor 1 makes a next trial to acquire the lock. In other words, the multi-processor system 101 inhibits the first processor 1 from accessing the shared resource 5, and the first processor 1 is placed in a lock wait state.

On the other hand, if it is determined that the first processor 1 can acquire the shared resource 5 (YES in step S5), the first processor 1 accesses the shared resource 5 and initiates executing of the lock of the shared resource 5. In other words, the multi-processor system 101 permits the first processor 1 to access the shared resource 5.

Then, the first processor 1 updates the lock wait information stored in the lock wait information storage unit 1b of itself to “the processor 1 is not in a lock wait state” (step S6). In addition, the flag indicating “resource has been acquired” is ON. After that, this lock acquirement operation ends.

Next, the advantages of the present invention will be described in comparison with Comparative Example.

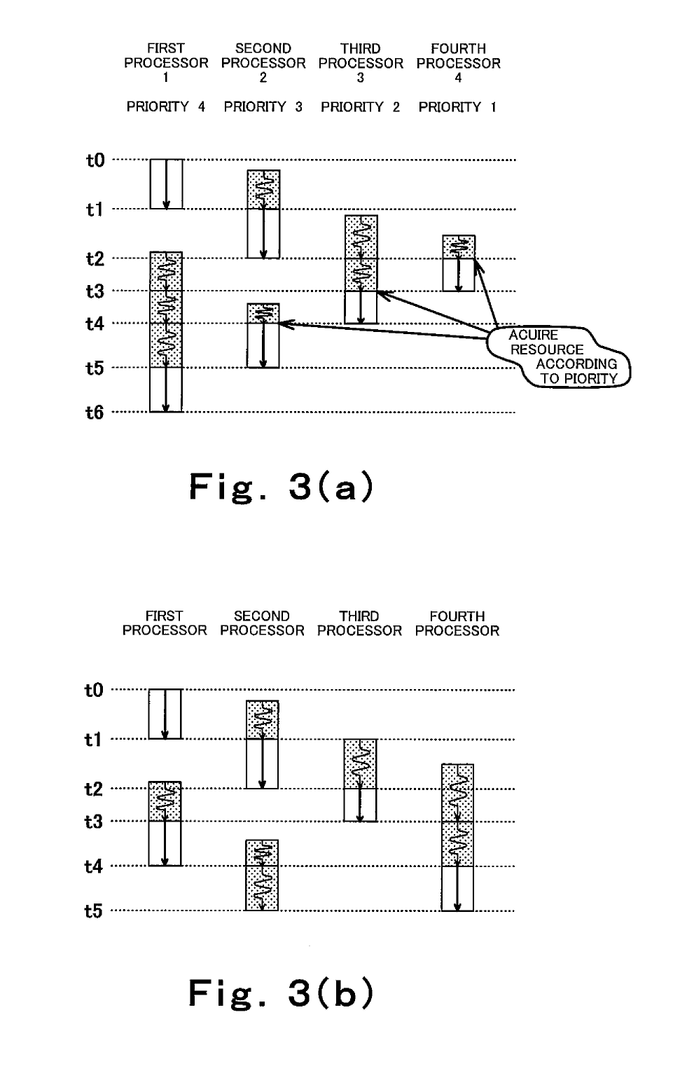

FIGS. 3(a) and 3(b) are schematic views showing the lock acquirement operation of the multi-processor system of FIG. 1, in comparison with the lock acquirement operation of Comparative Example, wherein FIG. 3(a) is a view showing the lock acquirement operation of the multi-processor system of FIG. 1, and FIG. 3(b) is a view showing the lock acquirement operation of Comparative Example.

In Comparative Example, the lock executed by the first to fourth processors is arbitrated by a distributed arbitration scheme in which the individual processors determine the order of the same request processing and execute the processing, which is disclosed in Japanese Laid-Open Patent Application Publication No. Hei. 2001-344195. In FIGS. 3(a) and 3(b), a vertical axis indicates time, each corrugated arrow indicates a lock wait state and each straight-line arrow indicates a lock execution state.

As shown in FIG. 3(b), in this Comparative Example, it is assumed that a fourth processor issues a request for locking a resource. Also, it is assumed that at that point of time, a third processor is in a lock acquirement wait state (see period of time t1˜t2). In the present Comparative Example, a success or a failure of the lock of the resource is determined by an instantaneous FIFO in lock request processing, and here it is assumed that the third processor has succeeded in locking of the resource. The fourth processor is placed in a lock acquirement wait state for a period of time until the third processor releases the lock of the resource (see period of time t2˜t3). Assuming that the first processor has succeeded in locking of the resource through a similar procedure, the fourth processor is placed in a lock acquirement wait state for a period of time until the first processor releases the lock of the resource (see period of time t3˜t4). If processing to be executed by the fourth processor has a higher priority, it cannot be done in real time.

In contrast, in the present embodiment, the lock is acquired as follows. In the present embodiment, the priority is set to decrease in the following order: the fourth processor 4, the third processor 3, the second processor 4, and the first processor 1.

As shown in the period of time t0˜t1 in FIG. 3(a), for example, in a case where a particular processor (in the present embodiment, second processor 2) is required to lock the shared resource 5, it tries a lock acquirement operation. If there does not exist another processor in a lock wait state at that point of time, the second processor 2 acquires the shared resource 5 and executes a lock (locks the shared resource 5), at the time point when a processor (in the present embodiment, first processor 1) which has acquired the shared resource 5 and is executing the lock finishes the lock. As shown in the period of time t1˜t2, in a case where a particular processor (in the present embodiment, third processor 3) is required to lock the shared resource 5, it tries a lock acquirement operation. If there exists another processor (in the present embodiment, fourth processor 4) in a lock wait state at that point of time, a processor (fourth processor 4) assigned with a higher priority, of the processor (third processor 3) and another processor (fourth processor 4) in a lock wait state, is permitted to access the shared resource 5. At the time point when a processor (in the present embodiment, second processor 1) which has acquired the shared resource 5 and is executing the lock finishes the lock, the processor (fourth processor 4) acquires the shared resource 5 and executes the lock. In the same manner, for example, as shown in the period of time t2˜t4, in a case where the first processor 1 is required to lock the shared resource 5, it tries a lock acquirement operation. If the third processor 3 is in a lock wait state at that point of time, the third processor 3 assigned with a higher priority, of the two processors, acquires the shared resource 5 and executes the lock, at the time point when the fourth processor 4 executing the lock finishes the lock. In the same manner, for example, as shown in a period of time t3˜t5, in a case where the second processor 2 is required to lock the shared resource 5, it tries a lock acquirement operation. If the first processor 1 is in a lock wait state at that point of time, the second processor 2 assigned with a higher priority, of the two processors, acquires the shared resource 5 and executes the lock, at the time point when the third processor 3 executing the lock finishes the lock.

In accordance with the multi-processor system 101 of the present embodiment, if there exists another processor in a lock wait state at the time point when a particular processor is required to lock the shared resource 5, the processor assigned with a higher priority, of these processors, acquires the shared resource 5 and executes the lock. As a result, real-time processing can be ensured.

### Embodiment 2

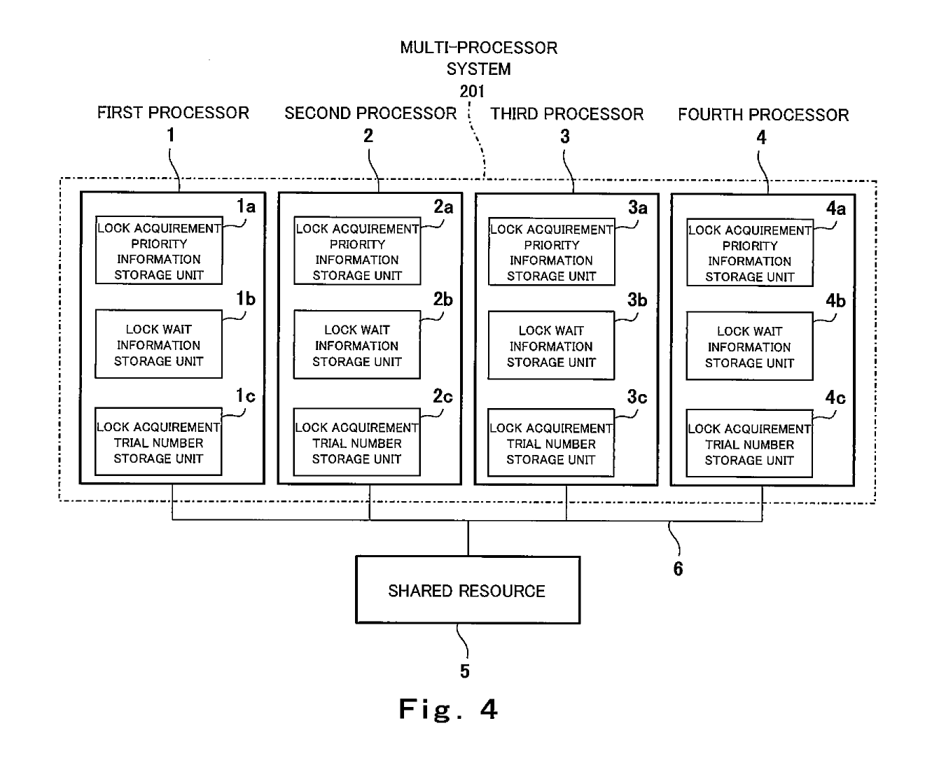

FIG. 4 is a circuit diagram showing a configuration of a multi-processor system according to Embodiment 2 of the present invention.

A multi-processor system 201 of the present embodiment is identical in basic configuration to the multi-processor system 101 of Embodiment 1 but is different from the same in that the lock acquirement priority is changed in the multi-processor system 201 of the present embodiment. Hereinafter, this difference will be in a large part described.

As shown in FIG. 4, in the multi-processor system 201 of the present embodiment, first to fourth processors 1˜4 include lock acquirement trial number storage units 1c, 2c, 3c, and 4c, respectively. The lock acquirement trial number storage units 1c, 2c, 3c, and 4c serve to store the number of times trial is made to acquire a lock, and are constituted by circuit elements capable of storing data. In the present embodiment, the lock acquirement trial number storage units 1c, 2c, 3c, and 4c are constituted by, for example, registers, respectively. The lock acquirement trial number is the number of times the processor tries to acquire the lock of the shared resource 5.

Next, the operation (lock arbitration method of the multi-processor system of present embodiment) of the multi-processor system configured as described above will be described.

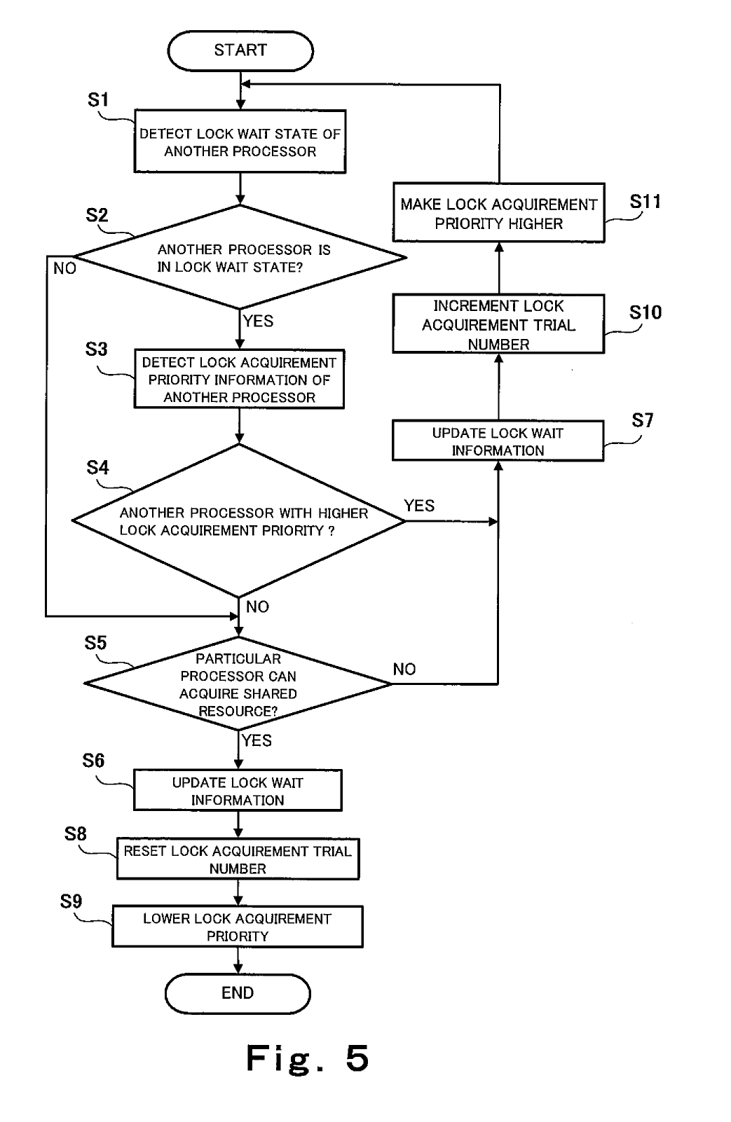

FIG. 5 is a flowchart showing a lock acquirement operation of one processor in the multi-processor system of FIG. 4.

Hereinafter, only the operation which is different from the operation of the multi-processor system 101 of Embodiment 1 will be described.

Step S1 to Step S7 are identical to those of Embodiment 1. In present embodiment, when the first processor 1 has failed to acquire the lock (YES in step S4, or NO in step S5), the first processor 1 updates the lock wait information (step S7) like Embodiment 1. Then, the first processor 1 increments the lock acquirement trial number (increases the number of times by one) stored in the lock acquirement trial number storage unit 1c (step S10).

Then, the first processor 1 makes the lock acquirement priority higher according to an increase in the lock acquirement trial number (step S11). For example, when the priority of the first processor 1 is “4” which is the initial value, the first processor 1 sets the priority to “3”.

Then, the process returns to step 51, and the first processor 1 performs a next trial to acquire a lock.

On the other hand, when the first processor 1 has succeeded in acquirement of the lock (acquirement of the shared resource 5) (YES in step S5), the first processor 1 updates the lock wait information (step S6) like Embodiment 1. Then, the first processor 1 resets the lock acquirement trial number stored in the lock acquirement trial number storage unit 1c to 0 (step S8).

Then, the first processor 1 lowers the lock acquirement priority which was made higher according to an increase in the lock acquirement trial number (step S9). For example, when the priority of the first processor 1 is currently “3” into which “4” as the initial value was changed, the first processor 1 sets “3” to “4” as the initial value.

After that, this lock acquirement operation finishes. In present embodiment, since the lock acquirement priority changes, there may be a chance that a plurality of processors have the same priority in some occasions. In those cases, if there exists another processor assigned with the same priority as that of the subject processor in step S4, one of them acquires the shared resource 5 by instantaneous FIFO in access processing to the shared resource 5 in step S5.

In accordance with the multi-processor system 201 configured as described above, it is possible to prevent the processor assigned with a lower priority as an initial value from continuing to be placed in a lock wait state for a long period of time, and hence real-time processing is totally improved.

Next, Modified Examples of present embodiment will be described.

### MODIFIED EXAMPLE 1

In Modified Example 1, the processors 1˜4 are respectively configured to change the lock acquirement priority information according to the priority of a task being executed or interrupt processing, instead of the number of times trial is made to acquire a lock.

To be specific, the processors 1˜4 update the lock acquirement priority information in task dispatch processing or interrupt entrance/exit processing. For example, when the first processor 1 performs dispatch from a task A to a task B, it changes the lock acquirement priority information from the priority of the task A to the priority of the task B. When an interrupt request for interrupt processing C is issued in a state where the task B is being executed and the task B shifts to the interrupt processing C, the first processor 1 changes the lock acquirement priority information to the priority of the interrupt processing C. In accordance with this configuration, the lock acquirement priority information is updated according to the priority of the task being executed in each of the processors 1˜4 or the interrupt processing, and the order in which the shared resource 5 is acquired is determined according to the lock acquirement priority information. Therefore, the order in which the shared resource 5 is acquired is determined according to the priority of the task being executed in each of the processors or the interrupt processing. As a result, real-time processing is ensured to details.

Alternatively, each of the processors 1˜4 may change the lock acquirement priority information according to the number of times a lock request is issued.

### MODIFIED EXAMPLE 2

In Modified Example 2, the processors 1˜4 are respectively configured to change the lock acquirement priority information periodically, instead of the number of times trial is made to acquire a lock. To be specific, each of the processors 1˜4, for example, updates the lock acquirement priority information to be higher, during execution of an event occurring periodically. This enables each of the processors 1˜4 to acquire a lock preferentially in every specific cycle and execute the event in real time. As a result, real-time processing is ensured to details.

Alternatively, each of the processors 1˜4 may change the lock acquirement priority information according to the number of times a lock request is issued.

### Embodiment 3

The multi-processor systems of Embodiments 1 and 2 may be applied to a variety of fields such as image processing or face recognition in digital cameras, image processing or face recognition in digital video cameras, image processing in digital television, and others. In Embodiment 3 of the present invention, discussion will be given of an example in which the multi-processor system 201 of Embodiment 2 is incorporated into a digital still camera, among the applications.

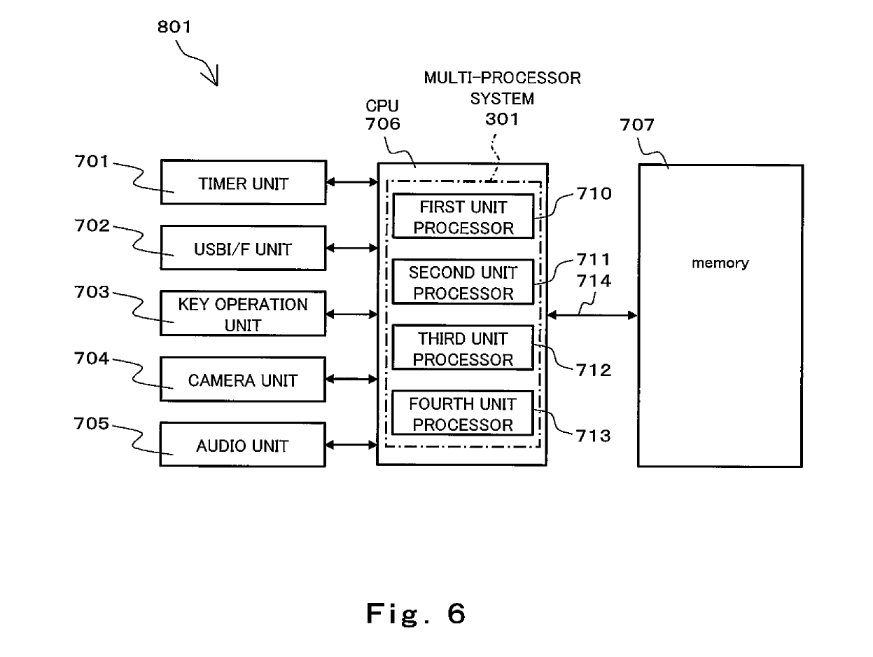

FIG. 6 is a block diagram showing a functional configuration of a digital still camera according to Embodiment 3 of the present invention.

As shown in FIG. 6, a digital still camera 801 of present embodiment includes a timer unit 701, a USB (Universal Serial Bus) interface unit 702, a key operation unit 703, a cameral unit 704, an audio unit 705, a CPU (Central Processing Unit) 706 and a memory 707.

The CPU 706 is connected to the memory 707 via a bus. The timer unit 701, the USB interface unit 702, the key operation unit 703, the camera unit 704, and the audio unit 705 are directly connected to the CPU 706. The CPU 706 and the memory 707 constitute at least a portion of a controller unit for controlling the operation of the digital still camera 801.

The CPU 706 controls the entire of the digital still camera 801 while processing plural tasks in parallel. To be specific, the CPU 705 reads an operating system program (OS) and various application programs stored in the memory 707 and executes them, in accordance with various command signals input with the key operation unit 703. In addition, the CPU 706 executes an interrupt handler according to an interrupt signal input from a peripheral chip including the cameral unit 704, the audio unit 705, or the like. For example, the CPU 706 processes a task generated by application in parallel. When an interrupt signal is input from the peripheral chip, a program corresponding to an interrupt is executed by executing the interrupt handler. The processing by application is executed as a task managed by a task scheduler of OS, and therefore, a service-call of OS can be called. In contrast, the interrupt processing is processing (non-task processing) which is not managed by the task scheduler. The CPU 706 stores various processing results in the memory 707.

The CPU 706 includes a multi-processor system 301. The multi-processor system 301 includes plural (four) processors, which are first to fourth unit processors 710˜713. The multi-processor system 301 is constituted by the multi-processor 201 of Embodiment 2. The first to fourth unit processors 710˜713 are constituted by the first to fourth processors of Embodiment 2, respectively. The memory 707 corresponds to the shared resource 5 of Embodiment 2.

Next, an operation sequence in the CPU 706 of the digital still camera configured as described above will be described. The operation sequence is essentially identical to the lock acquirement operation of the multi-processor 201 of Embodiment 2 and will be described with reference to FIG. 5. Although the flowchart of FIG. 5 shows lock acquirement operation of a single processor, the same operation occurs in the first to fourth unit processors 710˜713 along the flowchart of FIG. 5 and description will be given hereinafter as such.

As shown in FIG. 5, when it becomes necessary to call a service-call of OS (e.g., service-call or the like for reading out a control parameter stored in a system area of the memory 707), the first unit processor 710 firstly tries a lock acquirement operation and detects lock wait information of another unit processors 711˜713 (step 51).

Then, the first unit processor 710 determines whether or not another unit processors 711˜713 are in “lock wait state” at that point of time (step S2).

In this case, since another unit processors 711˜713 are not in “lock wait state” at that point of time (NO in step S2), the first unit processor 710 determines whether or not it can acquire the shared resource (in present embodiment, memory 707) (step S5). In this case, since another unit processors 711˜713 are not holding the shared resource (memory 707), the first unit processor 710 succeeds in acquirement of the shared resource (YES in step S5), calls the service-call of OS, and executes processing as OS.

When the second unit processor 711 tries to acquire a lock to call service-call of OS(e.g., service-call or the like for writing a control parameter in a system area of the memory 707) after the first unit processor 710 has succeeded in acquirement of the lock (acquirement of the shared resource), the first unit processor 710 is executing the lock in step S5, and therefore, the second unit processor 711 shifts to a lock wait state (step S7).

When the third unit processor 712 tries to acquire a lock to call service-call of OS(e.g., service-call or the like for writing a control parameter in a system area of the memory 707), the third unit processor 712 shifts to a lock wait state, like the second unit processor 711 (step S7).

During the lock wait state, the second and third unit processors 711 and 712 update their lock acquirement priority information. That is, each of the second and third unit processors 711 and 712 increments its lock acquirement trial number (step S 10), and makes the lock acquirement priority higher one by one every time the lock acquirement trial number is incremented (step S11).

When the service-call processing of OS being executed by the first unit processor 710 terminates and its lock finishes, a processor assigned with a higher lock acquirement priority, i.e., a processor which has tried to acquire a lock more times, of the second unit processor 711 and the third unit processor 712, succeeds in acquirement of a lock (acquirement of shared resource (memory 707)), and executes processing as OS.

In accordance with the digital still camera 801 of present embodiment as described above, overall operation is performed in real time at an improved level. For example, as described above, the memory is acquired in real time at an improved level. As a result, the digital still camera implements high-speed response in its autofocusing function, when taking pictures serially.

Although in Embodiment 1 to Embodiment 3, the present invention is applied to the multi-processor system and the CPU in the digital still camera, the present invention is not limited to these embodiments. The present invention can be implemented as an integrated circuit incorporating the above multi-processor system or implemented as programs for allowing a computer to operate as the above multi-processor. These programs may be distributed (delivered) via storage media such as CD-ROM or communication media such as Internet.

A multi-processor system and a lock arbitration method thereof of the present invention are useful as a multi-process system in which a plurality of processors require a lock of a resource, a lock arbitration method thereof, etc..

Numerous modifications and alternative embodiments of the present invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention.

### REFERENCE SIGNS LISTS

1 first processor

1a, 2a, 3a, 4a lock acquirement priority information storage unit

1b, 2b, 3b, 4b lock wait information storage unit

1c, 2c, 3c, 4c lock acquirement trial number storage unit

2 second processor

3 third processor

4 fourth processor

5 shared resource

6 bus

101, 201, 301 multi-processor system

701 timer unit

702 USB interface unit

703 key operation unit

704 camera unit

705 audio unit

706 CPU

707 memory

710 first unit processor

711 second unit processor

712 third unit processor

713 fourth unit processor

714 bus

801 digital still camera

What is claimed is:

1. A multi-processor system comprising:
a plurality of processors each configured to lock a shared resource and process a task;
each of the processors including a lock wait information storage unit for storing lock wait information indicating whether or not the processor is waiting for acquirement of a lock of the shared resource; and a lock acquirement priority information storage unit for storing lock acquirement priority information indicating a priority according to which the shared resource is acquired; and
each of the processors being configured to acquire the lock of the shared resource based on the lock wait information and the lock acquirement priority information.

2. The multi-processor system according to claim 1, wherein the lock acquirement priority information storage unit comprises a register for storing the lock acquirement priority information.

3. The multi-processor system according to claim 1 being configured not to change the lock acquirement priority information.

4. The multi-processor system according to claim 1, being configured to change the lock acquirement priority information.

5. The multi-processor system according to claim 4, being configured to change the lock acquirement priority information in a specific cycle.

6. The multi-processor system according to claim 4, wherein each of the processors is configured to change the lock acquirement priority information, according to a priority of a task being executed or interrupt processing.

7. The multi-processor system according to claim 4, wherein each of the processors is configured to change the lock acquirement priority information, according to the number of times trial is made to acquire the lock.

8. The multi-processor system according to claim 1, wherein the lock wait information storage unit comprises a register for storing the lock wait information.

9. A method of arbitrating a lock in a multi-processor system including a plurality of processors each configured to lock a shared resource and process a task; the method comprising:
storing lock wait information indicating whether or not each of the processors is waiting for acquirement of a lock of the shared resource, in each of the processors;
storing lock acquirement priority information indicating a priority according to which each of the processors acquires a lock of the shared resource, in each of the processors; and
acquiring the lock of the shared resource based on the lock wait information and the lock acquirement priority information, in each of the processors.

10. The method of arbitrating the lock in the multi-processor system according to claim 9, wherein each of the processors stores the lock acquirement priority information in a register.

11. The method of arbitrating the lock in the multi-processor system according to claim 9, wherein each of the processors does not change the lock acquirement priority information.

12. The method of arbitrating the lock in the multi-processor system according to claim 9, wherein each of the processors changes the lock acquirement priority information.

13. The method of arbitrating the lock in the multi-processor system according to claim 12, wherein each of the processors changes the lock acquirement priority information in a specific cycle.

14. The method of arbitrating the lock in the multi-processor system according to claim 12, wherein each of the processors changes the lock acquirement priority information, according to a priority of a task being executed or interrupt processing.

15. The method of arbitrating the lock in the multi-processor system according to claim 12, wherein each of the processors changes the lock acquirement priority information, according to the number of times trial is made to acquire the lock.

16. The method of arbitrating the lock in the multi-processor system according to claim 9, wherein each of the processors stores the lock wait information in a register.

17. A camera comprising:
a controller unit including the multi-processor system as recited in claim 1, and the shared resource locked by each of the processors constituting the multi-processor system;
the controller unit being configured to control an operation of the camera.
